(19) United States
(12) Patent Application Publication
(10) Pub. No.: US 2006/0020681 A1
(43) Pub. Date: Jan. 26, 2006

(54) Modification and importation of live web pages

(75) Inventors: Jeffrey Todd DePree, Fayetteville, NC (US); William Allen Smythe, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/897,816

(22) Filed: Jul. 23, 2004

(51) Int. Cl. G06F 15/16

(52) U.S. Cl. 709/217

(57) ABSTRACT

A mechanism is provided for modifying live web pages and then downloading the changed version. In one preferred embodiment, the user enters a uniform resource locator in a user interface. The mechanism then loads the page referenced by the uniform resource locator. The user is able to select an option in the user interface and have a corresponding action occur on the loaded web page. The mechanism of the present invention preserves the changes and stores the resulting web page as a template for further modification.

### BACKGROUND OF THE INVENTION

1. Technical Field

The present invention relates to data processing and, in particular, to web development. Still more particularly, the present invention provides a method, apparatus, and program for modification and importation of live web pages.

2. Description of Related Art

Web designers often base the design of web pages on pages that are already available on the Internet. In the case of web applications, such as those developed with Host Access Transformation Services, it is often desirable to base the design of a new application on the company's existing web site. If one were to use an existing site as the basis for a new site, one would need to import the web site, fixing links to point to their absolute addresses and downloading embedded files, and adapt the code to the specific purpose of the newly designed page, either by writing HTML content or by using a “page designer” application

The functionality to download web pages is included in web browser applications, such as Netscape Navigator® from Netscape Communications Corporation, and applications like Dreamweaver® from Macromedia, Inc. allow a developer to modify the downloaded web page using a graphical user interface (GUI). However, when using these development tools and applications, it is necessary to download the page in its current state and then insert, modify, or remove the saved resources.

### BRIEF SUMMARY OF THE INVENTION

The present invention recognizes the disadvantages of the prior art and provides a mechanism for modifying live web pages and then downloading the changed version. In one preferred embodiment, the user enters a uniform resource locator in a user interface. The mechanism then loads the page referenced by the uniform resource locator. The user is able to select an option in the user interface and have a corresponding action occur on the loaded web page. The mechanism of the present invention preserves the changes and stores the resulting web page as a template for further modification.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIGS. 4A and 4B illustrate example screens of display for a graphical user interface for modifying and importing live web pages in accordance with a preferred embodiment of the present invention;

FIG. 5 illustrates an exemplary directory and file structure that results from modifying and importing an existing, live web page into a project in accordance with a preferred embodiment of the present invention;

FIG. 6 illustrates an example header that may be added to a page so that the page may be integrated into a web project in accordance with a preferred embodiment of the present invention;

FIG. 7 is a block diagram depicting a mechanism for modification and importation of live web pages in accordance with an exemplary embodiment of the present invention;

FIGS. 8A-8C are flowcharts illustrating operation of a live web page modification and importation mechanism in accordance with a preferred embodiment of the present invention; and

FIG. 9 is a flowchart that illustrates the interaction among a modification and importation application, a web browser control, and a web project in accordance with an exemplary embodiment of the present invention.

### DETAILED DESCRIPTION OF THE INVENTION

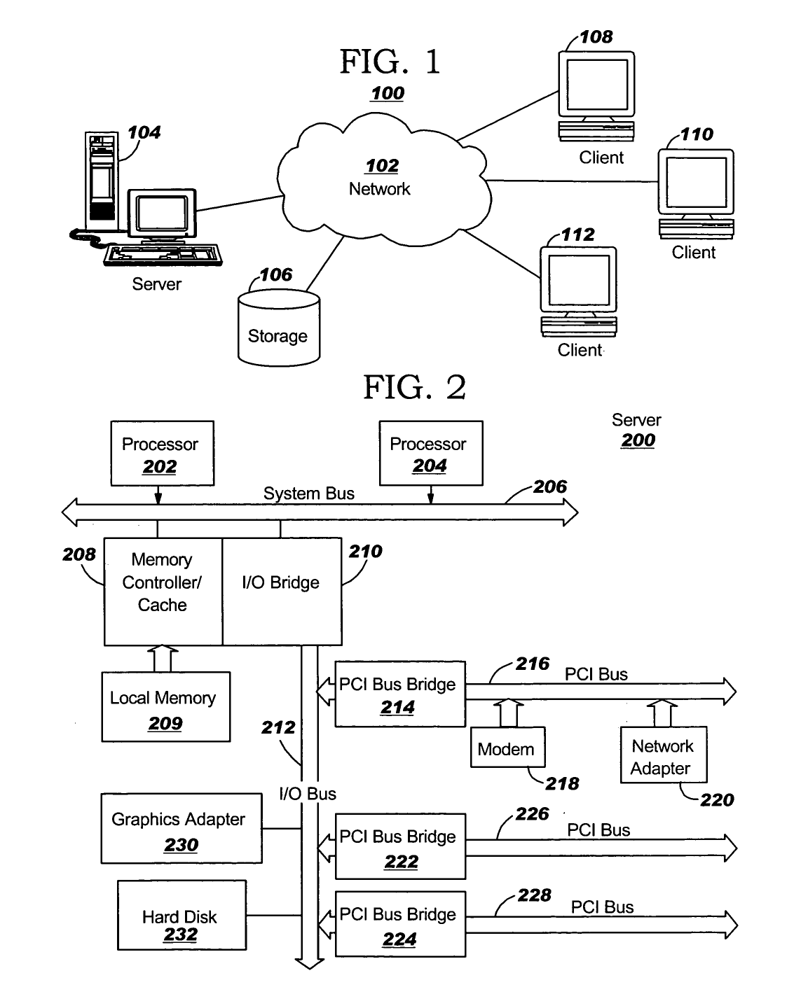

The present invention provides a method, apparatus and computer program product for modification and importation of live web pages. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In a preferred embodiment of the present invention, one or more of clients 108, 110, 112 include a mechanism for modifying live web pages and importing the modified web pages into a project. Server 104 may provide access to web pages in storage 106. The present invention provides a graphical user interface (GUI) that loads a requested web page and presents the web page for modification without having to store all of the components of the web page and all of the embedded files locally. The user may enter a uniform resource locator (URL) for a web page in a control in the GUI, which may be part of a Java™ application, for example.

The mechanism of the present invention employs a control for loading the page, such as, for example, an ActiveX® Internet Explorer control, which provides a control that acts as an Internet Explorer web browser client by Microsoft Corporation. The user is then able to select an option in the GUI to have a corresponding action occur on the web page. For example, the user may select an action to remove web page components when they are selected using a mouse. As another example, the user may select an action to insert components into the web page. As a further example, the user may move components in the loaded web page using a mouse cursor.

The mechanism of the present invention may obtain a document object model (DOM) for the web page using ActiveX®, for instance. DOM is an interface that presents a hypertext markup language (HTML) document to the developer as an object model for ease in updating. The mechanism then listens for mouse clicks and inserts or removes the specified components in the web page. The mechanism of the present invention may preserve the changes by creating an “UndoableAction” object that encapsulates the identification for the changed hypertext markup language (HTML) tag, as well as the prior and current HTML for that tag. It is possible to undo an unlimited number of operations using the GUI.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver™ pseries® system, a product of International Business Machines Corporation in Armonk, N.Y., running the Advanced Interactive Executive (AIX™) operating system or LINUX operating system.

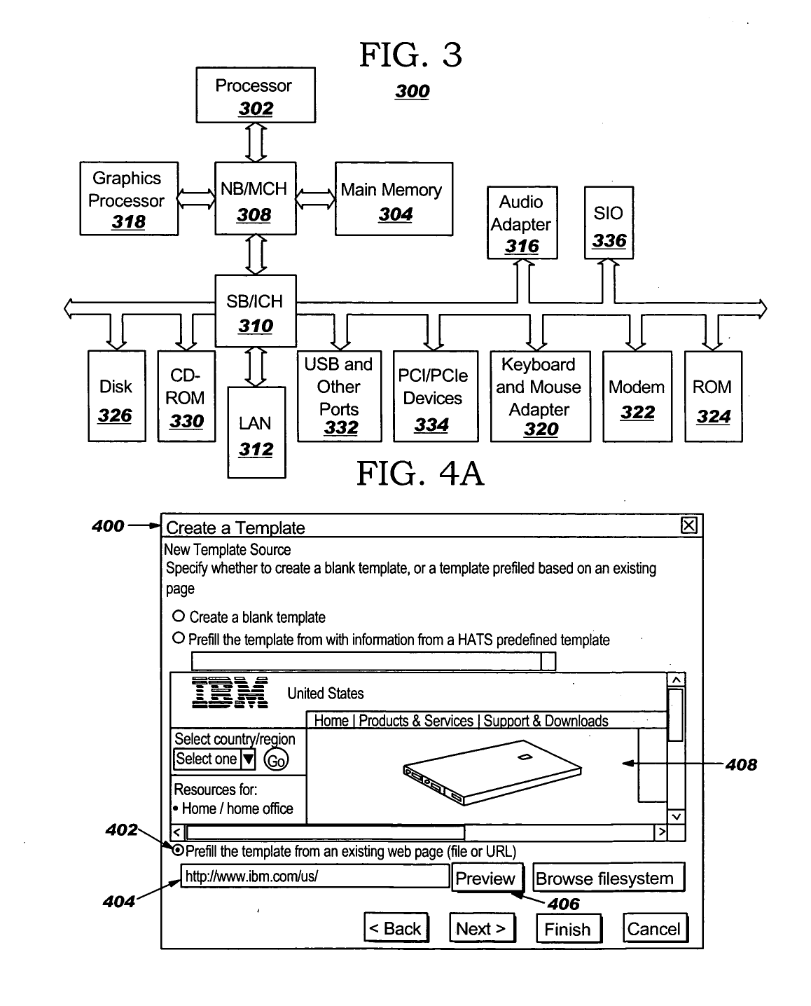

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

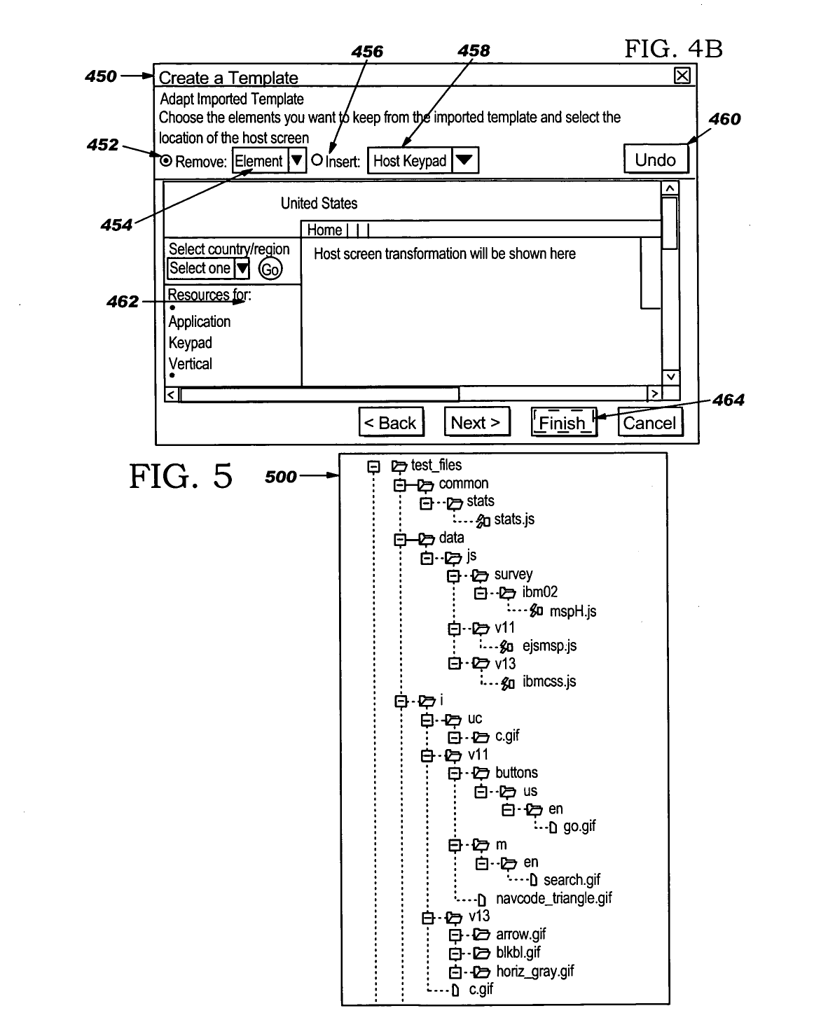

FIGS. 4A and 4B illustrate example screens of display for a graphical user interface for modifying and importing live web pages in accordance with a preferred embodiment of the present invention. More particularly, with reference to FIG. 4A, application window 400 provides a GUI for creating a template for a web project. In particular, application window 400 includes a radio control 402 for pre-filling the template from an existing, live web page. When radio control 402 is selected, the user may enter a URL into text entry field 404.

When the user finds the desired page, the user may select “Preview” button 406. Responsive to the user selecting “Preview” button 406, the selected web page is presented in display area 408, which may be, for example, an ActiveX® Internet Explorer control. Application window 400 may include other controls, such as, for example, navigation controls that may be used to navigate to the desired web page.

When the desired page is located, application window 450 may be presented, as illustrated in FIG. 4B. Application window 450 includes controls for adapting the imported template based on the existing, live web page. The user is then able to select an option in the GUI to have a corresponding action occur on the web page. For example, the user may select radio button 452 to remove web page components when they are selected using a mouse. Drop-down box 454 may be used to designate a component to remove. As another example, the user may select radio button 456 to insert components into the web page and drop-down box 458 may indicate the components to insert.

The application may create “UndoableAction” objects that identify the changed HTML tags, as well as the prior and current HTML for the tag. The user may then select “Undo” button 460 to undo the last action. It may be possible to undo any number, or perhaps an unlimited number, of operations.

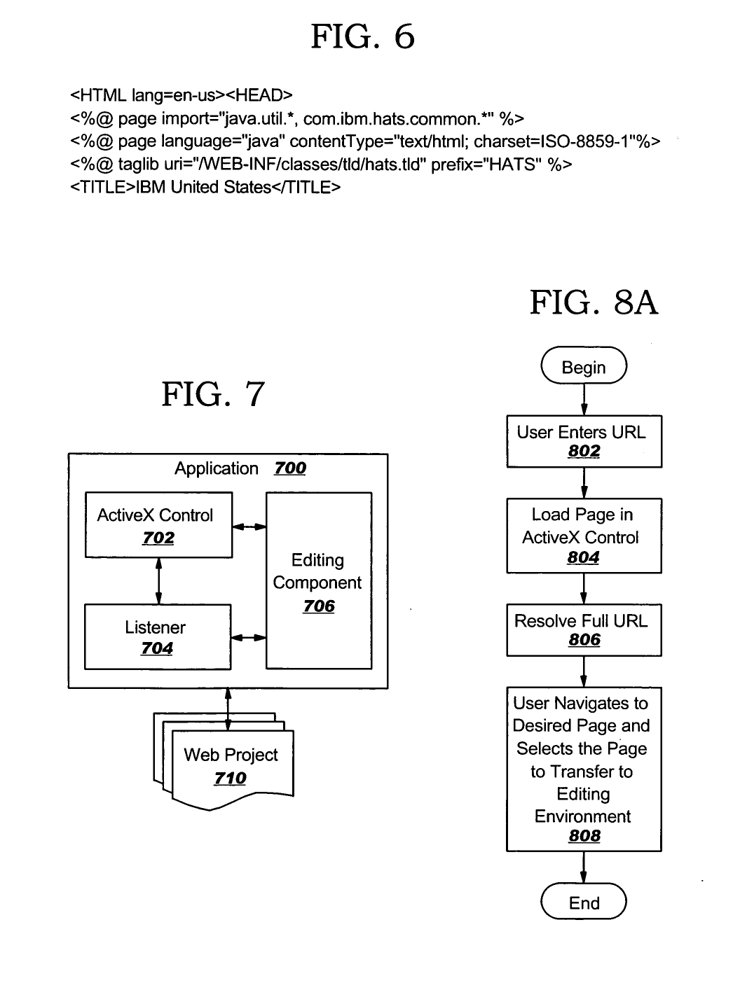

When the user is finished modifying the imported template, the user may select “Finish” button 464. Following the modifications, the application imports the web page and all resources involved into the developer's project. The application changes all of the links to include the necessary protocol and host. The application also downloads all images and scripts that are necessary for the page to display correctly. FIG. 5 illustrates an exemplary directory and file structure 500 that results from modifying and importing an existing, live web page into a project in accordance with a preferred embodiment of the present invention. FIG. 6 illustrates an example header that may be added to the page so that the page may be integrated into a web project in accordance with a preferred embodiment of the present invention.

FIG. 7 is a block diagram depicting a mechanism for modification and importation of live web pages in accordance with an exemplary embodiment of the present invention. Application 700 includes browser control 702, listener 704, and editing component 706. Responsive to a user inputting an address for a web page, such as an Internet protocol (IP) address or a URL, browser control 702 loads the desired page and presents the page to the user.

The user selects an option to have a corresponding action occur on the web page. Application 700 obtains a DOM for the web page using browser control 702. Listener 704 listens for mouse clicks and inserts or removes specified components in the page based on the option selected by the user. Modifications to the web page are made through interaction among listener 704, editing component 706, and browser control 702. When modifications are complete, application 700 exports the modified web page template into web project 710.

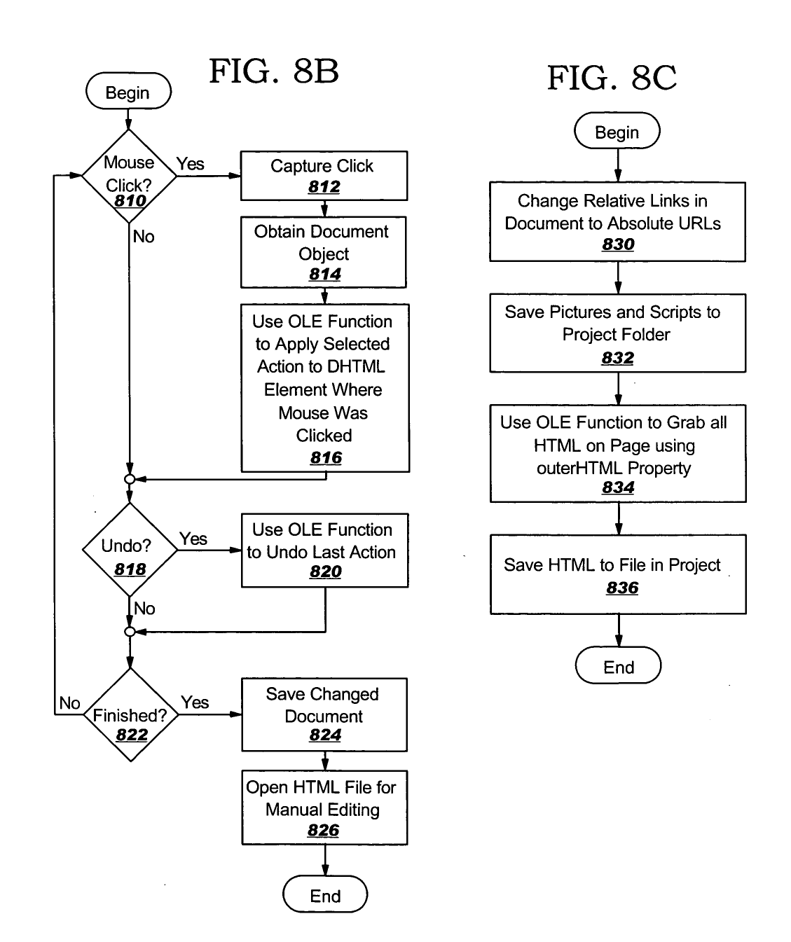

FIGS. 8A-8C are flowcharts illustrating operation of a live web page modification and importation mechanism in accordance with a preferred embodiment of the present invention. More particularly, FIG. 8A is a flowchart illustrating navigation and page preview. Operation begins and the user enters a URL for the desired page (block 802). Then, the mechanism of the present invention loads the page in a browser control (block 804). The mechanism then resolves the full URL of the page (block 806) and the user navigates to the desired page and selects the page to transfer to an editing environment (block 808). Thereafter, operation ends.

FIG. 8B is a flowchart that illustrates editing. Operation begins and a determination is made as to whether a mouse click occurs within the browser control (block 810). If a mouse click occurs, the mechanism of the present invention captures the click (block 812), obtains a document object for the web page (block 814), and uses an object linking and embedding (OLE) function to apply the selected action to a dynamic HTML (DHTML) element where the mouse was clicked (block 816). Dynamic HTML is a combination of HTML enhancements, scripting languages, and interfaces that are used to deliver animations, interactions, and dynamic updating on Web pages.

After the action is applied in block 816 or if a mouse click is not encountered in block 810, a determination is made as to whether an undo action is requested (block 818). If an undo action is requested, the mechanism uses an OLE function to undo the last action (block 820).

After the last action is undone in block 820 or if an undo action is not requested in block 818, a determination is made as to whether modification is finished (block 822). If modification is not finished, operation returns to block 810 to determine whether a mouse click is encountered. If modification is finished in block 822, the mechanism saves the changed document (block 824). Then, the mechanism opens the resulting HTML file for manual editing (block 826) and operation ends.

FIG. 8C is a flowchart illustrating saving of the imported web page. Operation begins and the mechanism changes relative links in the document to absolute URLs (block 830). Then, the mechanism saves pictures and scripts to a project folder (block 832). Next, the mechanism uses an OLE function to grab all HTML on the page using an outerHTML property (block 834). The outerHTML property can be any valid string containing a combination of text and tags. When the property is set, the given string completely replaces the object, including its start and end tags. If the string contains HTML tags, the string is parsed and formatted as it is placed into the document. Thereafter, the mechanism saves the HTML to a file in the developer's web project (block 836) and operation ends.

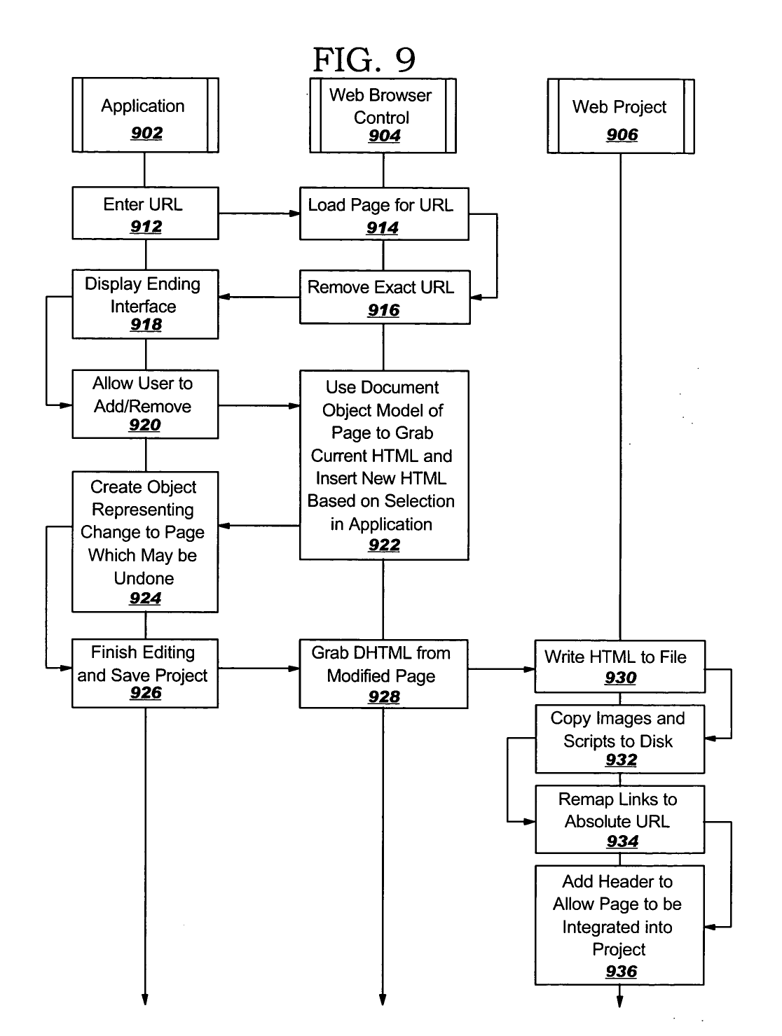

FIG. 9 is a flowchart that illustrates the interaction among a modification and importation application, a web browser control, and a web project in accordance with an exemplary embodiment of the present invention. Application 902 begins operation when a user enters a URL (block 912). Web browser control 904 loads the page for the URL (block 914) and resolves the exact URL for the page (block 916).

Then, application 902 displays an editing interface 918 and allows the user to add and/or remove components from the web page (block 920). Web browser control 904 then uses the DOM of the page to grab current HTML and to insert new HTML based on user selections in application 902 (block 922). Next, application 902 creates an object representing changes to the page that may be undone (block 924). Thereafter, the user finishes editing the page and application 902 saves the project (block 926).

Web browser control 904 grabs DHTML from the modified web page (928). Web project 906 writes HTML to file (block 930), copies images and scripts to disk (block 932), remaps links to absolute URLs (block 934), and adds a header to allow the page to be integrated into a project (block 936).

Thus, the present invention solves the disadvantages of the prior art by providing a mechanism for modifying live web pages and then downloading the changed version. In one preferred embodiment, the user enters a uniform resource locator in a user interface. The mechanism then loads the page referenced by the uniform resource locator. The user is able to select an option in the user interface and have a corresponding action occur on the loaded web page. The mechanism of the present invention preserves the changes and stores the resulting web page as a template for further modification.

The developer is able to edit the page with all of its functionality intact. Modifications are done in a true web browser control, rather than having to emulate one in an editor. The developer does not need to copy files or parts of the page that the developer does not intend to use. The developer can preview the modified version and determine whether it is worthwhile to use the page before copying any resources to disk.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for importing a web page into a project, the method comprising:
loading a given web page into a browser control in a graphical user interface;
responsive to user interaction, performing an action on at least one component in the given web page in the browser control to form a modified web page; and
storing the modified web page as a template in a web project.

2. The method of claim 1, wherein loading a given web page includes:
receiving a web address in an entry field in the graphical user interface;
retrieving the given web page referenced by the web address; and
presenting the given web page in the browser control.

3. The method of claim 2, wherein the web address is a uniform resource locator.

4. The method of claim 1, wherein loading a given web page includes navigating a set of linked web page until the given web page is presented.

5. The method of claim 1, wherein the given web page includes a plurality of components, wherein the user interaction includes selection of a given component from the plurality of components within the browser control, and wherein the action includes removing the given component from the given web page.

6. The method of claim 1, wherein the given web page includes a plurality of components, wherein the user interaction includes selection of a location on the given web page within the browser control, and wherein the action includes adding a given component to the given web page.

7. The method of claim 1, wherein the action includes undoing a previous action.

8. The method of claim 1, wherein storing the modified web page as a template includes importing the given web page and all files referenced in the modified web page.

9. The method of claim 1, wherein storing the modified web page as a template includes adding a header to the modified web page so that the modified web page may be added into the web project.

10. The method of claim 1, wherein storing the modified web page as a template includes changing links in the modified web page to include necessary protocol and host information.

11. An apparatus in a data processing system for importing a web page into a project, the apparatus comprising:
a browser control in a graphical user interface, wherein the browser control loads and presents a given web page;
a listener that listens for user interaction in the browser control; and
an editing component that performs an action on at least one component in the given web page in the browser control responsive to the user interaction to form a modified web page,
wherein the apparatus stores the modified web page as a template in a web project.

12. The apparatus of claim 11, wherein the graphical user interface includes an entry field that receives a web address and wherein the browser control retrieves the given web page referenced by the web address and presents the given web page.

13. The apparatus of claim 11, wherein the browser control includes controls for navigating a set of linked web page until the given web page is presented.

14. The apparatus of claim 11, wherein the action includes one of removing the given component from the given web page, adding a given component to the given web page, and undoing a previous action.

15. The apparatus of claim 11, wherein the editing component adds a header to the modified web page so that the modified web page may be added into the web project.

16. The apparatus of claim 11, wherein the editing component changes links in the modified web page to include necessary protocol and host information.

17. A computer program product in a computer readable medium for importing a web page into a project, the computer program product comprising:
instructions for loading a given web page into a browser control in a graphical user interface;
instructions for responsive to user interaction, performing an action on at least one component in the given web page in the browser control to form a modified web page; and
instructions for storing the modified web page as a template in a web project.

18. The computer program of claim 17, wherein the instructions for loading a given web page includes:
instructions for receiving a web address in an entry field in the graphical user interface;
instructions for retrieving the given web page referenced by the web address; and
instructions for presenting the given web page in the browser control.

19. The computer program of claim 18, wherein the web address is a uniform resource locator.

20. The computer program of claim 17, wherein the instructions for loading a given web page includes instructions for navigating a set of linked web page until the given web page is presented.

21. The computer program of claim 17, wherein the given web page includes a plurality of components, wherein the user interaction includes selection of a given component from the plurality of components within the browser control, and wherein the action includes removing the given component from the given web page.

22. The computer program of claim 17, wherein the given web page includes a plurality of components, wherein the user interaction includes selection of a location on the given web page within the browser control, and wherein the action includes adding a given component to the given web page.

23. The computer program of claim 17, wherein the action includes undoing a previous action.

24. The computer program of claim 17, wherein the instructions for storing the modified web page as a template includes instructions for importing the given web page and all files referenced in the modified web page.

25. The computer program of claim 17, wherein the instructions for storing the modified web page as a template includes instructions for adding a header to the modified web page so that the modified web page may be added into the web project.

26. The computer program of claim 17, wherein the instructions for storing the modified web page as a template includes instructions for changing links in the modified web page to include necessary protocol and host information.
